(19) United States
(12) Patent Application Publication
(10) Pub. No.: US 2015/0267650 A1
(43) Pub. Date: Sep. 24, 2015

(54) VENTURI EGR PUMP

(71) Applicant: International Engine Intellectual Property Company, LLC, Lisle, IL (US)

(72) Inventors: Grzegorz Siuchta, Des Plaines, IL (US); Russell P. Zukouski, Bolingbrook, IL (US)

(21) Appl. No.: 14/223,019

(22) Filed: Mar. 24, 2014

(51) Int. Cl. F02M 25/07; F02M 21/02; F02B 37/00

(52) U.S. Cl. CPC F02M 25/0717; F02B 37/00; F02M 21/0215; F02M 25/0726

(57) ABSTRACT

An exhaust gas recirculation venturi pump for drawing an exhaust gas from an exhaust manifold of an internal combustion engine through an exhaust gas recirculation system. The exhaust gas recirculation venturi pump includes a first passageway that at least in part is configured to provide a venturi effect using the flow of an air/fuel mixture through the exhaust gas recirculation venturi pump. At least the decrease in pressure of the air/fuel mixture created by the venturi effect may draw an exhaust gas from the exhaust manifold into the exhaust gas recirculation venturi pump. Moreover, the suction provided by the venturi effect may pull the exhaust gas through an exhaust gas recirculation system, even when the exhaust gas pressure at the exhaust gas manifold is equal to or greater than the pressure of the intake charge at the intake manifold.

### BACKGROUND

Exhaust gas recirculation (EGR) is a technique that is commonly used to reduce nitrogen oxide (NOₓ) emissions in internal combustion engines. EGR works by recirculating a portion of an engine's exhaust gas back to the engine's cylinders. For example, EGR may divert exhaust gas to a location upstream of the cylinders, such as, for example, to an intake manifold of the engine. In at least some internal combustion engines, the re-circulated inert exhaust gas displaces an amount of combustible matter in the cylinder. In other types of engines, the exhaust gas replaces some of the excess oxygen in the pre-combustion air/fuel mixture. Because NOₓ forms primarily when a mixture of nitrogen and oxygen is subjected to high temperature, the lower combustion chamber temperatures caused by EGR may reduce the amount of NOₓ the combustion event generates. As a result, modern engines commonly use EGR to meet emission standards.

Modern engine systems typically include an electronic engine control unit (ECU) that controls operation of the engine based on measurements provided by a plurality of sensors. Based on at least some measurements provided by sensors, and/or through the ability of the ECU to predict engine operating conditions, the ECU may be able to predict the quantity of exhaust gas that should be diverted by an EGR system back to the engine's cylinders. The ECU may seek to control the quantity of exhaust gas that is to be re-circulated back to the intake manifold of the engine through the operation of a controllable EGR valve.

Currently, natural gas spark ignited engines in automotive applications may run with stoichiometric air-to-fuel ratios and relatively high EGR % levels. The stoichiometric air/fuel mixtures and EGR levels for natural gas spark ignition engines may improve engine efficiency and power by increasing resistance to knock combustion and enabling application of higher compression ratios. Further, such air/fuel mixtures and EGR levels may allow for the inclusion of an after treatment system having a three-way catalyst for treating potential pollutants in the exhaust gas that is not utilized by EGR system.

However, when a natural gas ignition sparked engine is turbocharged, the turbocharger compressor that compresses air from an air inlet may exceed the engine air demand. In such situations, the air exiting the compressor may have a pressure that is higher than the pressure of exhaust gas that is exiting the exhaust manifold and which is to be used by the EGR system.

In such situations, in order to provide desired EGR flow to the intake manifold and/or engine cylinder in a short EGR loop configuration, an intake air throttle that controls the flow of compressed air that is to be mixed with the natural gas may need to be utilized relatively extensively. More specifically, such situations may require heavy intake air throttling in at least an attempt to maintain a stoichiometric air/fuel mixture and desired EGR rates. However, such extensive control, and resulting restriction, on the quantity of air and fuel flowing to the intake manifold may result in a reduction of engine efficiency and performance.

Additionally, currently, stoichiometric spark ignition natural gas engines run a standard high pressure EGR loop that includes an EGR mixer. The mixer is configured to mix air that has passed through a compressor and a charged air cooler and a fuel to create an intake manifold charge mixture or intake charge. Further, a significant pressure gradient between the exhaust manifold and the intake manifold is typically is used to drive a desired exhaust gas flow through the EGR system. However, a standard EGR mixer may create an additional restriction in the EGR exhaust gas flow path.

### SUMMARY

According to certain embodiments of the illustrated technology, an exhaust gas recirculation venturi pump is provided for drawing an exhaust gas from an exhaust manifold of an internal combustion engine through an exhaust gas recirculation system. The exhaust gas recirculation venturi pump includes a first passageway having an inlet. The first passageway is configured for the flow of an air/fuel mixture through the exhaust gas recirculation venturi pump. The exhaust gas recirculation venturi pump also includes an exhaust gas passageway having an inlet and an outlet, the outlet of the exhaust gas passageway being positioned downstream of the inlet of the first passageway. Additionally, the first passageway includes a venturi section that is configured to increase a flow rate, and decrease a pressure, of the air/fuel mixture in at least a portion of the first passageway to levels that provide a suction force to pull exhaust gas through at least the exhaust gas passageway and into the first passageway.

Additionally, according to certain embodiments of the illustrated technology, an exhaust gas recirculation venturi pump is provided that includes an exhaust gas passageway that is in fluid communication with an exhaust manifold of an internal combustion engine. The exhaust gas passageway has an inlet and an outlet. The exhaust gas recirculation venturi pump also includes a first passageway that is in fluid communication with a compressor. The first passageway includes a first section, a tapered section, and a second section. The second section has a cross sectional size that is smaller than a cross sectional size of the first section and is positioned downstream of the first section. The outlet of the exhaust gas passageway is positioned in proximity to an inlet of the second section. Further, the tapered section is configured to increase a flow rate and decrease a pressure of an air/fuel mixture that is flowing toward the second section to levels that provide a suction force to pull exhaust gas through at least the exhaust gas passageway and into the second section.

Additionally, according to certain embodiments of the illustrated technology, a method for recirculating an exhaust gas generated by the operation of an internal combustion engine is provided. The method includes delivering a first portion of an exhaust gas to an exhaust manifold of the internal combustion engine. Additionally, the pressure of an intake air is elevated by an air compressor to provide a high pressure air. The high pressure air is mixed with a fuel to provide an air/fuel mixture that is delivered to an exhaust gas recirculation venturi pump. The pressure of at least a portion of the delivered air/fuel mixture in the exhaust gas recirculation venturi pump is decreased to provide a suction force that is used to pull the first portion of the exhaust gas into the exhaust gas recirculation venturi pump. At least a portion of the air/fuel mixture and the first portion of the exhaust gas in the exhaust gas recirculation venturi pump are mixed together to provide an intake charge. The intake charge is delivered to the intake manifold.

### BRIEF DESCRIPTION OF THE DRAWINGS

FIG. 1 illustrates a block diagram of a natural gas spark ignited engine system that includes an EGR system having an EGR venturi pump according to an illustrated embodiment.

FIG. 2 illustrates a cross sectional view of an EGR venturi pump according to an illustrated embodiment.

### DETAILED DESCRIPTION

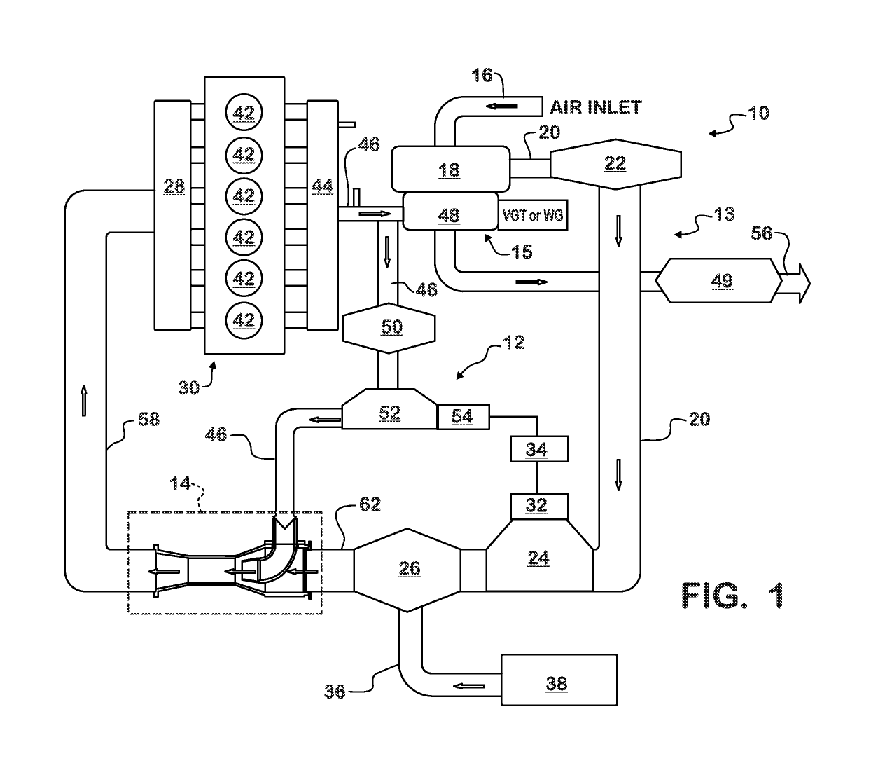

FIG. 1 illustrates a block diagram of a natural gas spark ignited engine system 10 that includes an EGR system 12 having an EGR venturi pump 14 according to an illustrated embodiment. As shown, air for use in the operation of the engine system 10, such as, for example, for use during an internal combustion process, may flow through an air intake line 16 that includes various hoses and/or tubes. Air may then pass through into a compressor 18, such as, for example, a compressor used for a turbocharger 15. The compressed air exiting the compressor 18 may then pass along a portion of an air line 20 before flowing into a charge air cooler 22, which is configured to reduce the temperature of the compressed air.

The cooled, compressed air may then flow along another portion of the air line 20 and to an intake air throttle 24. The intake air throttle 24 may be configured to control the flow, and more specifically, the quantity of cooled, compressed air that is being mixed with fuel, such as natural gas. Moreover, the intake air throttle 24 may be configured to control the flow of cooled, compressed air to a gas mixer 26 so as to control the air-to-fuel ratio of an air/fuel mixture that may be delivered to an intake manifold 28 of an engine 30. The positioning of a valve of the intake air throttle 24, and thus the quantity of cooled, compressed air that flows through the intake air throttle 24, may be controlled by the operation of a motor or solenoid 32 that is controlled by an electronic control unit or module (ECU) 34.

Cooled, compressed air that flows through the intake air throttle 24 may then flow into a natural gas mixer 26, which is also supplied with a fuel via a fuel line 36 from a fuel source 38, such as, for example, a fuel tank that may contain compressed or liquefied natural gas. The quantity of cooled, compressed air and natural gas mixed in the gas mixer 26 may be used at least in an attempt to attain a desired air-to-fuel ratio, such as, for example, the air/fuel mixture reaching a stoichiometric ratio. An air/fuel mixture may then exit the gas mixer 26 and pass via hose or tubing to the EGR venturi pump 14, where the flow of the air/fuel mixture may be used to draw or exhaust gas into the EGR venturi pump 14, as discussed below, before proceeding to an intake manifold 28 of the engine 30.

Exhaust gases generated by the combustion of the fuel in the cylinders 42 of the engine 30 may flow out of the exhaust manifold 44 of the engine 30 and into an along at least one exhaust line 46. According to certain embodiments, at least a portion of the exhaust line 46 may be configured to deliver at least a portion of the exhaust gas to a turbine 48, such as the turbine 48 of the turbocharger 15. The turbine 48 may have a variety of different configurations, such as being a variable geometry turbine (VGT) or waste gated turbine (WGT). Further, the flow of exhaust gas through the turbine 48 may generate power used to operate the compressor 18, and more specifically, power used by the compressor 18 to compress the air, as previously discussed.

The exhaust gas that flows through the turbine 48 may then be delivered to an after treatment system 13. According to certain embodiments, the after treatment system 13 may include a three-way catalyst 49, as well as other after treatment components, such as, for example, a particulate filter. Typically, the use of a three-way catalyst 49 requires stoichiometric combustion. However, the stoichiometric combustion events associated with internal combustion engines often result in relatively high exhaust gas temperatures that preclude the use of a three-way catalyst 49. However, the use of the EGR venturi pump 14 allows for sufficient EGR exhaust gas flow rates that may dilute the intake charge to the intake manifold 28. The dilution of the intake charge that may be attainable through the use of the EGR venturi pump 14 may result in stoichiometric combustion that produces relatively low exhaust gas temperatures that are suitable for use with a three-way catalyst 49. Following treatment by the after treatment system 12, according to certain embodiments, the exhaust gas may flow out of the after treatment system 13 and into the atmosphere through a tailpipe 56.

At least a portion of the exhaust line 46 may also be configured to deliver at least a portion of the exhaust gas released through the exhaust manifold 44 to the EGR system 12 for recirculation back to the engine 30. According to certain embodiments, the EGR system 12 may include an EGR cooler 38 and the EGR valve 40. For example, according to certain embodiments, the exhaust gas in the EGR system 12 may flow through an EGR cooler 50, which may act as or include a heat exchanger so as to cool or reduce the temperature of the exhaust gas. The exhaust gas in the EGR system 12 may also flow through an EGR valve 52, which may be positioned downstream or upstream of the EGR cooler 38. The EGR valve 52 may be configured to at least assisting in controlling the quantity or flow rate of exhaust gas that is recirculated back to the engine 30. For example, the EGR valve 52 may include one or more flapper valves, among other types of valves, that are adjustable between open and closed positions, and positions there between, through the operation of a motor 54. The operation of the motor 54, and thus the positioning of valves of the EGR valve 52, may be controlled by the ECU 34. Exhaust gas that flows through the EGR valve 52 may then be delivered via a portion of the exhaust line 46 to the EGR venturi pump 14.

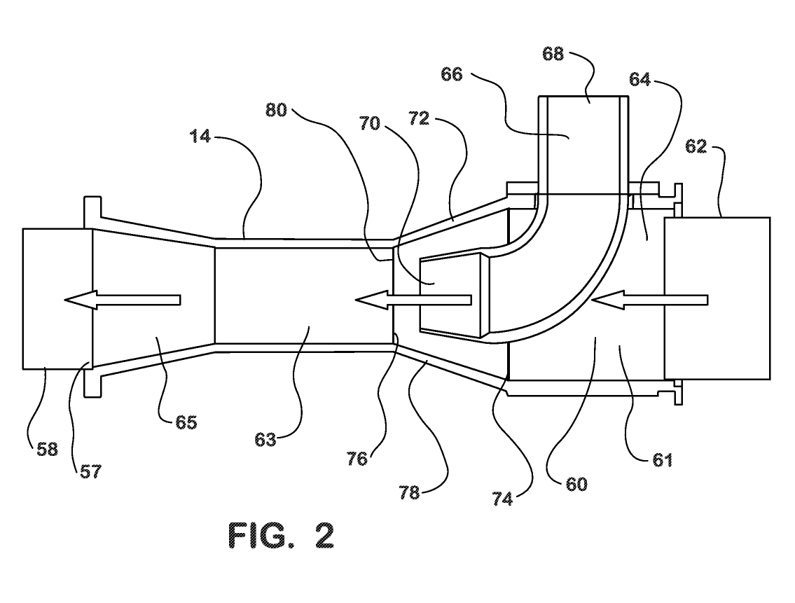

As shown in FIGS. 1 and 2, the EGR venturi pump 14 includes a first passageway 60 that is in fluid communication with the gas mixer 26. For example, an air/fuel line 62 may deliver the air/fuel mixture from an outlet of the gas mixer 26 to the first passageway 60 through an inlet 64 of the EGR venturi pump 14. Additionally, according to certain embodiments, the EGR venturi pump 14 may also include an exhaust gas passageway 66 having an inlet 68 and an outlet 70. The inlet 68 may be operably connected to the exhaust gas line 46 such that exhaust gas passageway 66 receives exhaust gas that has passed through the EGR cooler 50 and/or the EGR valve 52.

According to certain embodiments, the EGR venturi pump 14 is configured to utilize the cooled, compressed air in the air/fuel mixture as a motive fluid to drive a desired flow of exhaust gas in the EGR system 12 into the EGR venturi pump 14. For example, according to certain embodiments, at least a portion of the first passageway 60 has a configuration that accelerates the speed at which the air/fuel mixture flows through the first passageway 60, while also reducing the static pressure of the air/fuel mixture. Such a configuration may be provided by configuring the first passageway 60 to provide a venturi effect.

For example, according to certain embodiments, the first passageway 60 may have a first section 61 and a second section 63 that are generally separated by a tapered section 72. The second section 63 may have a cross sectional size, such as, for example, a diameter, that is smaller than the cross sectional size, such as diameter, of the first section 61. For example, as shown in FIGS. 1 and 2, the tapered section 72 may have a tapered or inwardly angled wall 78 that provides a transition from the larger first section 61 to the smaller second section 63. Thus, the wall 78 of the tapered section 72 may transition from a first end 74 that is adjacent to the first section 61 to a second end 76 that is adjacent to the second section 63.

Such a configuration of the tapered section 72 may create a funnel through which the velocity at which the air/fuel mixture is flowing through the tapered section 72 increases as the corresponding size of the first passageway 60 decreases. Further, as the velocity of the air/fuel mixture increases, the corresponding static pressure of the air/fuel mixture decreases. Thus, the static pressure of the air/fuel mixture in the second section 63 of the first passageway 60 may be smaller than the corresponding static pressure in the first section 61.

Such decrease in the static pressure of the air/fuel mixture may create a vacuum that pulls exhaust gas through the EGR system 14 and into the second portion 61 of the first passageway 60. Thus, according to certain embodiments, the outlet 70 of the exhaust gas passageway 66 may be positioned at or around the second end 76 of the tapered section 72 and/or the inlet 80 of the second section 63. Further, according to certain embodiments, the outlet 70 of the exhaust gas passageway 66 may be in a generally central location about the second end 76 of the tapered section 72 and/or the inlet 80 of the second section 63.

Alternatively, the EGR venturi pump 14 may be configured such that the motive fluid, namely, the air/fuel mixture, is introduced into the first passageway 60 a central location. For example, referencing FIG. 2, in an alternative embodiment, exhaust gas from the EGR system 12 may be drawn into the EGR venturi pump 14 through the inlet 64 of the first passageway 60, while the previously identified exhaust gas passageway 66 may instead deliver the air/fuel mixture, rather than exhaust gas, into the first passageway 60. According to such an embodiment, the air/fuel mixture may remain the motive fluid for drawing exhaust gas in the EGR system 12 into the EGR venturi pump 14 by creating a pressure difference in the EGR venturi pump 14 that draws exhaust gas into the EGR venturi pump 14.

The exhaust gas that is drawn into the first passageway 60 may then be mixed in at least the second section 63 and/or third section 65 of the EGR venturi pump 14. Thus, besides being used in drawing the exhaust gas from and/or through the EGR system 12, the EGR venturi pump 14 may also function as a mixer for the air/fuel mixture and exhaust gas.

Additionally, the third section 65 of the first passageway 60 may have a generally outwardly tapered configuration from the second section 63 such that the third section expands to a cross sectional size that is larger than the cross sectional size of the second section 63. Such an increase in cross sectional size may decrease the flow rate of the air/fuel and exhaust gas mixture as that mixture is approaching the outlet 57 of the EGR venturi pump 14.

The air/fuel and exhaust gas mixture may flow out of the EGR venturi pump 14 and into a supply line 58 that delivers the air/fuel and exhaust gas mixture to the intake manifold 28 of the engine 30. The supplied air/fuel and exhaust mixture may then be supplied to the cylinders 42 of the engine, wherein a spark ignited combustion event may be used to displace the pistons of the engine 30, thereby transmitting the force of the combustion events into mechanical power that is used to drive the drivetrain of the associate vehicle. The resulting hot exhaust gas and associated particulate matter, such as soot, produced by or during the combustion event(s) may then flow out of the cylinders 42 and engine 30 through the exhaust manifold 44, as previously discussed.

By using the air/fuel mixture to pull exhaust gas through at least a portion of the EGR system 14, the EGR venturi pump 14 may prevent the conventional use of relatively excessive throttling of the air intake throttle 24 to satisfy the desired rate flow rate of recirculated exhaust gas when the compressor 18 exceeds the air demand of the engine 30. Further, the EGR venturi pump 14 may create sufficient suction force to attain desired flow rates for exhaust gas in the EGR system 12, such as, for example, EGR exhaust gas rates greater than 20% of the total inlet charge.

Further, by utilizing the EGR venturi pump 14, the system 10 may attain benefits associated with using an exhaust gas having a pressure, at the exhaust manifold 44, that is generally equal to or less than the pressure of the air/fuel mixture at the intake manifold 28. For example, with an exhaust gas pressure equal to or lower than the air/fuel pressure at the intake manifold 28, pumping losses associated with relatively excessive throttling of the intake air throttle 24, such as, for example, losses due to intake and exhaust gas exchanges associated with an internal combustion engine operating cycle, may be eliminated and/or decreased. Further, such reduction in pump losses may result in a decrease in fuel consumption.

Additionally, as previously discussed, the EGR venturi pump 14 utilizes a suction force created by the flow of the air/fuel mixture in at least the EGR venturi pump 14 to pull exhaust gas through the EGR system 12. Moreover, when using such suction, the system 10 may be able to not rely on a pressure gradient between the exhaust manifold 44 and intake manifold 28 to pull exhaust gas through the EGR system 12. Thus, when the EGR venturi pump 14 is used, the pressure of the exhaust gas at the exhaust manifold 44 does not necessarily need to be at a higher pressure than the pressure of the intake charge at the intake manifold 28. Instead, the EGR venturi pump 14 may be used in drawing exhaust gas through the EGR system 12 at least when the pressure of the exhaust gas at the exhaust manifold is equal to or lower than the pressure of the intake charge at the intake manifold 28. Further, a lower pressure exhaust gas at the exhaust manifold 44 may, under the thermodynamic gas principle, translate into lower exhaust gas temperature. Additionally, the temperature of the exhaust gas may be further reduced by the higher concentration of EGR exhaust gas in the intake charge associated with the exhaust gas flow rates attained by the suction force provided through use of the EGR venturi pump 14.

The ability to use exhaust gas at pressures equal to or below the pressure of the air/fuel mixture at the intake manifold 28, as well as the associated lower exhaust gas temperature, may be beneficial to the operation of components of the system 10. For example, the lower exhaust gas temperatures may provide a better match for the turbocharger 15, including for particular VGT applications. Additionally, the system 10 may experience an increase in engine torque and engine power due to improved tolerance for engine knocking from the resulting higher flow rates of exhaust gas from the EGR system 12 and lower exhaust manifold 44 back pressures.

1. An exhaust gas recirculation venturi pump for drawing an exhaust gas from an exhaust manifold of an internal combustion engine through an exhaust gas recirculation system, the exhaust gas recirculation venturi pump comprising:
a first passageway having an inlet, the first passageway configured for the flow of an air/fuel mixture through the exhaust gas recirculation venturi pump; and
an exhaust gas passageway having an inlet and an outlet, the outlet of the exhaust gas passageway being positioned downstream of the inlet of the first passageway;
wherein the first passageway includes a venturi section that is configured to increase a flow rate, and decrease a pressure, of the air/fuel mixture in at least a portion of the first passageway to levels that provide a suction force to pull exhaust gas through at least the exhaust gas passageway and into the first passageway.

2. The exhaust gas recirculation venturi pump of claim 1, wherein the internal combustion engine is a natural gas spark ignited engine.

3. The exhaust gas recirculation venturi pump of claim 2, wherein the first passageway is in fluid communication with a compressor of a turbocharger.

4. The exhaust gas recirculation venturi pump of claim 1, wherein at least a portion of the first passageway is configured to mix the exhaust gas with the air/fuel mixture.

5. An exhaust gas recirculation venturi pump comprising:
an exhaust gas passageway in fluid communication with an exhaust manifold of an internal combustion engine, the exhaust gas passageway having an inlet and an outlet; and
a first passageway in fluid communication with a compressor, the first passageway having a first section, a tapered section, and a second section, the second section having a cross sectional size that is smaller than a cross sectional size of the first section, the second section being positioned downstream of the first section, the outlet of the exhaust gas passageway being positioned in proximity to an inlet of the second section;
wherein the tapered section is configured to increase a flow rate and decrease a pressure of an air/fuel mixture flowing toward the second section to levels that provide a suction force to pull exhaust gas through at least the exhaust gas passageway and into the second section.

6. The exhaust gas recirculation venturi pump of claim 5, wherein the exhaust gas passageway is in fluid communication with a cooler of an exhaust gas recirculation system, the cooler being positioned upstream of the exhaust gas recirculation venturi pump.

7. The exhaust gas recirculation venturi pump of claim 5, wherein the internal combustion engine is a natural gas spark ignited engine.

8. The exhaust gas recirculation venturi pump of claim 7, wherein at least a portion of the first passageway is configured to mix the exhaust gas with the air/fuel mixture to provide an intake charge.

9. The exhaust gas recirculation venturi pump of claim 7, wherein the first passageway further includes a third section downstream of the second section, the third section being operably connected to a supply line for the delivery of the intake charge to an intake manifold of the internal combustion engine.

10. A method for recirculating an exhaust gas generated by the operation of an internal combustion engine, the method comprising:
delivering a first portion of an exhaust gas to an exhaust manifold of the internal combustion engine;
elevating the pressure of an intake air by an air compressor to provide a high pressure air;
mixing the high pressure air with a fuel to provide an air/fuel mixture;
delivering the air/fuel mixture to an exhaust gas recirculation venturi pump;
decreasing the pressure of at least a portion of the delivered air/fuel mixture in the exhaust gas recirculation venturi pump to provide a suction force;
pulling, using the suction force, the first portion of the exhaust gas into the exhaust gas recirculation venturi pump;
mixing at least a portion of the air/fuel mixture and the first portion of the exhaust gas in the exhaust gas recirculation venturi pump to provide an intake charge; and
delivering the intake charge to the intake manifold.

11. The method of claim 10, wherein the step of mixing the high pressure air with the fuel including mixing the high pressure air and the fuel at a ratio that provides a stoichiometric air/fuel mixture.

12. The method of claim 12, wherein the internal combustion engine is a natural gas spark ignited engine.

13. The method of claim 11, further including the step of delivering a second portion of the exhaust gas to a three-way catalyst, the three-way catalyst configured to treat one or more pollutants in the second portion of the exhaust gas.

14. The method of claim 13, further including the step of delivering at least a portion of the second portion of the exhaust gas to a turbine of a turbocharger, the turbine being upstream of, and in fluid communication with, the three-way catalyst.

15. The method of claim 10, wherein the first portion of the exhaust gas in the exhaust manifold has a first pressure, and the intake charge in the intake manifold has a second pressure, the second pressure being higher than the first pressure.
